(19) United States
(12) Patent Application Publication
(10) Pub. No.: US 2026/0303820 A1
(43) Pub. Date: Oct. 1, 2026

(54) ENHANCED GEOMETRICAL PARTITIONING MODE

(71) Applicant: Telefonaktiebolaget LM Ericsson (publ), Stockholm (SE)

(72) Inventors: Ruoyang YU, TÄBY (SE); Per WENNERSTEN, ÅRSTA (SE); Jack ENHORN, BÅLSTA (SE); Kenneth ANDERSSON, GÄVLE (SE)

(73) Assignee: Telefonaktiebolaget LM Ericsson (publ), Stockholm (SE)

(21) Appl. No.: 19/473,969

(22) PCT Filed: Mar. 26, 2024
(86) PCT No.: PCT/SE2024/050274

§ 371 Date: Oct. 9, 2025

Related U.S. Application Data
(60) Provisional application No. 63/458,988, filed on Apr. 13, 2023.

(51) Int. Cl. H04N 19/139; H04N 19/119; H04N 19/159; H04N 19/176; H04N 19/52

(52) U.S. Cl. CPC H04N 19/139; H04N 19/119; H04N 19/159; H04N 19/176; H04N 19/52

(57) ABSTRACT

A method for decoding a current block within a current picture inside a coded video bitstream. The method comprises determining that the current block is coded using geometric partition mode, GPM. The method comprises, in response to determining that the current block is coded using GPM, determining that at least one partition, PX, of the current block is inter coded. The method further comprises, in response to determining that at least one partition, PX, is inter coded, generating a GPM motion information list, LIST_FINAL. The method comprises determining motion information, MI_PX, associated with the partition, PX, based on the GPM motion information list, LIST_FINAL, and an index value, IDX, wherein the associated motion information, MI_PX, contains more than one motion vector. The method comprises determining prediction samples of the partition PX based on the associated motion information MI_PX.

### TECHNICAL FIELD

Disclosed are embodiments related to enhanced geometrical partitioning mode.

### BACKGROUND

### VVC and ECM

Versatile Video Coding (VVC) is a block-based video codec standardized by ITU-T and MPEG.

Enhanced Coding Model (ECM) is an exploratory codec which is currently under development. The aim of ECM is to demonstrate and try providing evidence of video coding capabilities beyond VVC. The current ECM version (as of the writing of this disclosure) is ECM-8.0.

### Video and Picture

A video sequence consists of a series of pictures. In VVC, each picture is identified with a picture order count (POC) value. The POC value also represents display order of the picture. A picture with a smaller POC value is displayed before another picture with a larger POC value.

### Components

Each component can be described as a two-dimensional rectangular array of sample values. It is common that each picture consists of three components; one luma component Y, where the sample values are luma values; and two chroma components Cb and Cr, where the sample values are chroma values.

It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as color components.

### Coding Unit and Coding Block

A block is one two-dimensional array of samples. In video coding, each component is split into blocks and the coded video bitstream consists of a series of coded blocks. It is common in video coding that pictures are split into units that cover a specific area of the picture.

Each unit consists of all blocks from all components that make up that specific area and each block belongs fully to one unit. The Coding Unit (CU) in VVC is an example of units. In VVC the CUs may be split recursively to smaller CUs. The CU at the top level is referred to as the coding tree unit (CTU).

A CU usually contains three coding blocks, i.e., one coding block for luma and two coding blocks for chroma. The size of luma coding block is the same as the CU.

In VVC, the CUs can have size of 4×4 up to 128×128. In current ECM, the CUS can have size of 4×4 up to 256×256.

### Parameter Sets, Slice Headers and Picture Headers

VVC specifies three types of parameter sets, the picture parameter set (PPS), the sequence parameter set (SPS) and the video parameter set (VPS). The PPS contains data that is common for a whole picture, the SPS contains data that is common for a coded layer video sequence (CLVS), and the VPS contains data that is common for multiple CLVSs, e.g., data for multiple layers in the bitstream.

The concept of slices divides the picture into independently coded slices, where decoding of one slice in a picture is independent of other slices of the same picture. Each slice has a slice header comprising syntax elements. Decoded slice header values from these syntax elements are used when decoding the slice.

In VVC, a coded picture contains a picture header. The picture header contains parameters that are common for all slices of the coded picture.

### Intra Prediction

In intra prediction, also known as spatial prediction, a block is predicted using the previous decoded blocks within the same picture. The samples from the previously decoded blocks within the same picture are used to predict the samples inside the current block.

A picture consisting of only intra-predicted blocks is referred to as an intra picture.

### Inter Prediction

In inter prediction, also known as temporal prediction, blocks of the current picture are predicted using blocks from previously decoded pictures. The samples from blocks in the previously decoded pictures are used to predict the samples inside the current block.

A picture that allows inter-predicted block is referred to as an inter picture. The previous decoded pictures used for inter prediction are referred to as reference pictures.

The location of the referenced block inside the reference picture is indicated using a motion vector (MV). Each MV consists of x and y components which represents the displacements between current block and the referenced block in x or y dimension. The value of a component may have a resolution finer than an integer position. When that is the case, a filtering (typically interpolation) is done to calculate values used for prediction. FIG. 1 shows an example of a MV for the current block C.

An inter picture may use several reference pictures. The reference pictures are usually put into two reference picture lists, L0 and L1. The reference pictures that are output before the current picture are typically the first pictures in L0. The reference pictures that are output after the current picture are typically the first pictures in L1.

Inter predicted blocks can use one of two prediction types, uni- and bi-prediction. A uni-predicted block predicts from one reference picture, either using L0 or L1. Bi-prediction predicts from two reference pictures, one from L0 and the other from L1. FIG. 2 shows an example of the prediction types.

### Picture Coding Type (Low-Delay Picture and Non-Low-Delay Picture)

A low-delay picture is a picture that has all its reference pictures displayed before the picture. In other words, for a low delay picture, all its reference pictures have smaller POC values than the current POC.

A non-low-delay picture is a picture that has at least one of its reference pictures displayed after the picture. In other words, a non-low-delay picture has at least one reference picture with a larger POC value than the current POC.

### Fractional MVs, Interpolation Filter, and MV Rounding

The value of the MV's x or y component may corresponds to a sample position which has finer granularity than integer (sample) position. Those positions are also referred to as fractional (sample) positions.

In VVC and current ECM, the MV can be at 1/16 sample position. FIG. 3 depicts several fractional positions in the horizontal (x-) dimension. The solid square blocks represent integer positions. The circles represent 1/16-position. For example, MV=(4, 10) means the x component is at 4/16 position, the y component is at 10/16 position.

In video coding, a MV rounding process is sometimes used to convert a MV at one position to another target position. One example of rounding is to round a fractional MV position to the nearest integer position.

When a MV is at a fractional position, filtering (typically interpolation) is done to calculate the sample values at those positions. In VVC, the length (number of filter taps) of the interpolation filter for luma component is 8, as shown in the table below. In ECM, the length of the interpolation filter for luma component has been increased to 12.

| Fractional | | | | | | | | |
|---|---|---|---|---|---|---|---|---|
| sample | interpolation filter coefficients | | | | | | | |
| position p | f_{L}[p][0] | f_{L}[p][1] | f_{L}[p][2] | f_{L}[p][3] | f_{L}[p][4] | f_{L}[p][5] | f_{L}[p][6] | f_{L}[p][7] |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 | −1 | 4 | −11 | 40 | 40 | −11 | 4 | −1 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

### Residual, Transform and Quantization

The difference between samples of a source block (contains original samples) and samples of the prediction block, also called residual block, is then typically compressed by a spatial transform to remove further redundancy. The transform coefficients are then quantized by a quantization parameter (QP) to control the fidelity of the residual block and thus also the bitrate required to compress the block. A coded block flag (CBF) is used to indicate if there are any non-zero quantized transform coefficients. All coding parameters are then entropy coded at the encoder and decoded at the decoder. If the coded block flag is one, a reconstructed block can then be derived by inverse quantization and inverse transformation of the quantized transform coefficients and then add that to the prediction block. If the coded block flag is zero, the reconstructed block is identical to the prediction block.

### Inter Prediction Information/Motion Information

For an inter block inside an inter picture in VVC, its inter prediction information consists of the following three elements:

(1) A reference picture list flag (RefPicListFlag). The flag signals which reference picture list is used for the block.

When the value of the flag is equal to 0, it means only L0 is used for predicting the current block. When the value of the flag is equal to 1, it means only L1 is used for predicting the current block. When the value of the flag is equal to 2, it means both L0 and L1 are used for predicting the current block.

(2) A reference picture index (RefPicIdx) per reference picture list used. The index signals which reference picture inside the reference list to be used for predicting the current block.

(3) A motion vector (MV) per reference picture used. It signals the position inside the reference picture that is used for predicting the current block.

The inter prediction information is also referred to as motion information. The decoder stores the motion information for each inter block. In other words, an inter block maintains its own motion information.

### Encoder Decision and Rate Distortion (RD) Cost

In practice for an encoder to decide the best prediction mode for a current block, it would evaluate all the possible prediction modes for the current block and select the prediction mode that yields the smallest Rate-Distortion (RD) cost.

The RD cost is calculated as D+λ*R. The D (Distortion) measures the difference between the reconstructed block and the corresponding source block. One commonly used metric for calculating D is the sum of squared error SSE=Σ_{x,y}(P_{A}(x, y)−P_{B}(x, y))², where the P_{A} and P_{B} are the sample values in the two blocks A and B respectively. The R (rate) is usually an estimation of the bits to be spent on encoding the mode. The λ is a trade-off parameter between R and D.

### Motion Information Signaling

VVC and ECM includes several methods for implicit signaling of motion information for each block, including the merge method and the subblock merge method. A common motivation behind the implicit methods is to inherit or reuse motion information from neighboring coded blocks. This often works in practice due to spatial correlation of close-by blocks, i.e., the fact that nearby blocks often behave similarly.

### Merge (Block Merge) Method and Merge Mode

The merge method derives a set of motion information from previously decoded blocks and use the derived motion information for generating the samples of the entire block. The merge method is sometimes referred to as the block merge method.

The method first generates a list of motion information candidates. The list is also referred to as the merge list. The candidates are derived from previously coded blocks. These previously coded blocks can be spatially adjacent neighboring blocks or temporal collocated blocks relative to the current block. FIG. 4 shows the spatial neighboring blocks: left (L), top (T), top-right (TR), left-bottom (LB) and top-left (TL).

The merge list construction process usually checks the previously coded blocks in a predefined order, for example, T-L-TR-LB-TL. For each previously coded block being checked, if this previously coded block is inter coded and its motion information has no duplicates in the list, then the motion information of this previously coded block is added to the merge list.

After the merge list is generated, one of the candidates inside the list is used to derive the motion information of the current block. The candidate selection process is done on the encoder side. An encoder would select a best candidate from the list and encode an index (merge_index) in the bitstream to signal to a decoder. The decoder receives the index, it follows the same merge list derivation process as the encoder, and uses the index to retrieve the correct candidate.

The blocks that use the block merge method are sometimes referred to as blocks in merge mode.

In the current ECM, non-adjacent spatial blocks are also considered as sources of motion information during the merge list construction. FIG. 5 shows some examples (marked with NA1, NA2, and NA3) of those non-adjacent spatial blocks.

### Subblock Merge Method

VVC and ECM also include the subblock merge method. It splits a current block into a number of subblocks and allows each subblock to have its own motion information. FIG. 6 shows an example of a current block and its subblocks. Each subblock maintains its own motion information. It should be noted that the subblocks are all rectangular.

### Geometric Partitioning Mode (GPM)

VVC and ECM also include a more flexible partition method called GPM, where a block can be split into two partitions by a splitting line. And the splitting line is defined using an angle index (α) and a distance index (ρ), as shown in FIG. 7.

GPM adds possibilities of splitting a block into two parts which are not necessarily always rectangular. FIG. 8 shows some more examples of different partitions in GPM, where the black area corresponding to one partition and the white area corresponding to the other partition. The corresponding angle index and distance index are shown as ordered pairs in FIG. 8 for each given mode.

In VVC and the current ECM, GPM allows 64 different modes. Each mode corresponds to a unique way to split a block into two parts, in other words, each mode corresponds to a unique splitting line. Each mode is indicated with an index in a coded video bitstream. The following table shows the mapping between the 64 different modes with the corresponding angle and distance index.

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

Each partition in GPM is associated with a set of motion information, and each partition inherits its motion information from previously coded blocks.

The motion information derivation relies on generating a GPM motion information candidate list first. After the list is generated, one of the candidates inside the list is used to derive the motion information of the partition.

An encoder would select a candidate from the list and encode an index in the bitstream to signal to a decoder. The decoder receives the index, it follows the same candidate list generation process as the encoder and uses the index to retrieve the correct motion information for the partition.

### GPM Motion Information List Generation

The motion information list used in the existing GPM design is a list of uni-motion information where each motion information entry only contains L0 or L1 motion vector. In other words, each motion information entry in the list only uses L0 motion vector or L1 motion vector.

The GPM motion information list generation comprises two steps. The first step is to derive an initial motion information list. In VVC and current ECM, the initial motion information list process is the same as the block merge candidate list derivation process. After the initial motion information list is derived, an extraction process is invoked to extract motion information containing only Uni-MV from entries in the initial motion information list.

The following table shows an example of the initial motion information list with 4 entries.

| Index | Motion information |
|---|---|
| 0 | RefPicListFlag = 3 (both L0 and L1 is used) |

| | |
|---|---|
| RefPicIdx L0: 1 | RefPicIdx L1: 0 |
| MV L0: (−1, 2) | MV L1: (1, −2) |

| | |
|---|---|
| 1 | RefPicListFlag = 3 (both L0 and L1 is used) |

| | |
|---|---|
| RefPicIdx L0: 0 | RefPicIdx L1: 0 |
| MV L0: (1, 1) | MV L1: (0, 0) |

| | |
|---|---|
| 2 | RefPicListFlag = 1 (only L0 is used) |

RefPicIdx L0: 0
MV L0: (2, 2)

| | |
|---|---|
| 3 | RefPicListFlag = 1 (only L0 is used) |

RefPicIdx L1: 1
MV L1: (1, 3)

The following table shows an example of a GPM motion information list with uni-motion information entries. As can be noticed, each entry in the GPM motion information list is extracted from the corresponding entry in the initial motion information list. And each entry in the GPM motion information list only contains L0 motion vector or L1 motion vector.

| Index | Motion information | |
|---|---|---|
| 0 (Extracted from the L0 of | RefPicListFlag = 1 (only L0 is used) | |
| candidate with index 0 in | RefPicIdx L0: 1 | |
| the initial motion information | MV L0: (−1, 2) | |
| list) | | |
| 1 (Extracted from the L1 of | RefPicListFlag = 2 (only L1 is used) | |
| candidate with index 1 in the | | RefPicIdx L1: 0 |
| initial motion information | | MV L1: (0, 0) |
| list) | | |
| 2 (Extracted from the L0 of | RefPicListFlag = 1 (only L0 is used) | |
| candidate with index 2 in the | RefPicIdx L0: 0 | |
| initial motion information | MV L0: (2, 2) | |
| list) | | |
| 3 (First try extract from the | RefPicListFlag = 1 (only L0 is used) | |
| L1 of candidate with index 3 | RefPicIdx L1: 1 | |
| in the initial motion information | MV L1: (1, 3) | |
| list, but there was no available | | |
| L1 information, so L0 is | | |
| extracted instead) | | |

GPM-MMVD (GPM with Merge Motion Vector Difference)

The current ECM extends the GPM design in VVC with a tool GPM-MMVD to add possibilities of explicitly signaling an MVD (motion vector difference) to the inherited motion vector (of the inherited motion information). The motivation of GPM-MMVD is to further adjust the inherited motion vector to better cater for the corresponding GPM partition, since in some cases, the motion vector used for the previously decoded block may not well-suitable for the content of the current partition.

It should be noted that GPM-MMVD only modifies the motion vector, the inherited reference picture list flag and inherited reference picture index are kept unmodified.

The MVD is signaled as a pair of distance and direction. There are nine candidate distances (¼-sample, ½-sample, 1-sample, 2-sample, 3-sample, 4-sample, 6-sample, 8-sample, 16-sample), and eight candidate directions (four horizontal/vertical directions and four diagonal directions).

FIG. 9 shows an example of GPM-MMVD where the 8 possible MVD direction is shown with dashed arrows. The “baseMVPart1” is the base MV (the inherited MV) for the MVD. And the “modifiedMvPart1” is the adjusted MV from the base MV and the MVD.

For each partition, a GPM-MMVD flag is signaled to indicate the usage of GPM-MMVD. When the value of the flag is 1, a GPM-MMVD index is further signaled for the MVD.

GPM-TM (GPM with Template Matching)

ECM adds a method called GPM-TM to refine the inherited motion vector. Comparing to GPM-MMVD which relies on explicitly signaling of MVD to adjust an inherited motion vector, GPM-TM implicitly refines the inherited motion vector with the help of template matching method. However, similar to GPM-MMVD, GPM-TM only refines the motion vector, the inherited reference picture list flag and inherited reference picture index are kept unmodified.

Based on the GPM partition mode, a template is assigned to each partition. The template can be constructed using left, above, or left and above neighboring reconstructed samples.

For example, FIG. 10 shows the GPM mode index 10 (with angle index of 4 and distance index of 0). For partition Part0, its template is from the above neighboring reconstructed samples. For partition Part1, its template is from the left neighboring reconstructed samples.

For each partition, the motion vector is refined further by minimizing the difference between the template in the current picture and the template in the reference picture. The existing design in GPM-TM is uni-template matching since the associated MV (from the associated motion information) are uni-MV. FIG. 11 shows an example for the template matching process for Part0 (when GPM mode index=10). The template matching process searches an area near the base MV baseMvPart0 (i.e., the inherited MV) to find whether there is another MV refinedMvPart0 that gives the best template matching results. The refined MV refinedMvPart0 is then used as the MV for generating prediction samples of the partition.

For a GPM block, a GPM-TM flag is signaled to indicate the usage of GPM-TM. When the value of the flag is 1, the GPM-TM method is applied on both partitions. In other words, current ECM does not allow to use GPM-TM for one partition but not the other when GPM-TM is enabled for the GPM block.

### GPM-Intra

In VVC, both partitions of GPM are inter-coded. ECM includes a tool called GPM-Intra to allow usage intra prediction for one of the partitions in GPM.

### Overlapped Block Motion Compensation (OBMC)

OBMC is a tool included in ECM which operates at the block boundaries or subblock boundaries of a current inter block. OBMC blends the current block's or subblock's prediction sample (generated using the current associated motion information) with another set of prediction samples which are generated using the neighboring motion information. The OBMC may give better prediction for samples that are close to the block or subblock boundary.

### Bi-Directional Optical Flow (BDOF)

BDOF is a tool included in VVC and the current ECM that can be used to refine prediction samples that are generated from a Bi-MV. BDOF relies on optical flow estimation to derive a pair of refinement parameter (Vx, Vy) which can be further used to refine the prediction samples.

### Decoder-Side Motion Vector Refinement (DMVR)

DMVR is a tool included in VVC and the current ECM to refine motion vectors for a Bi-MV. DMVR operates on subblock level, usually 16×16. Different from BDOF that relies on optical flow estimation, DMVR relies on bilateral matching of two reference blocks to refine the Bi-MV. The DMVR searches within a window around the Bi-MV to find whether there exists another Bi-MV (Bi-MV′) that gives a better match between the L0 reference block and the L1 reference block. If so, the Bi-MV′ is further used instead for generating the prediction samples of the current block.

### SUMMARY

The current GPM scheme in ECM as well as in VVC only uses one motion vector (Uni-MV) for generating prediction samples for each partition, which may lead to inferior prediction accuracy.

Embodiments modify the existing GPM design to allow usage of more than one motion vector for generating prediction samples for each partition in GPM. Embodiments also modify the existing GPM related tools such as GPM-MMVD and GPM-TM are to allow for usage of more than one motion vector.

According to a first aspect of the present disclosure, there is provided a method for decoding a current block within a current picture inside a coded video bitstream. The method comprises determining that the current block is coded using geometric partition mode, GPM. The method comprises, in response to determining that the current block is coded using GPM, determining that at least one partition, PX, of the current block is inter coded. The method comprises, in response to determining that at least one partition, PX, is inter coded, generating a GPM motion information list, LIST_FINAL. The method further comprises determining motion information, MI_PX, associated with the partition, PX, based on the GPM motion information list, LIST_FINAL, and an index value, IDX, wherein the associated motion information, MI_PX, contains more than one motion vector. The method comprises determining prediction samples of the partition PX based on the associated motion information MI_PX.

According to a second aspect of the present disclosure, there is provided a decoder adapted to perform the method according the first aspect.

According to a third aspect of the present disclosure, there is provided a computer program comprising instructions which when executed by processing circuitry of a node, causes the node to perform the method according the first aspect.

According to a fourth aspect of the present disclosure, there is provided a carrier containing the computer program according to the third aspect, wherein the carrier is one of an electronic signal, an optical signal, a radio signal, and a computer readable storage medium.

At least one of the embodiments have an advantage of improved coding efficiency.

### BRIEF DESCRIPTION OF THE DRAWINGS

The accompanying drawings, which are incorporated herein and form part of the specification, illustrate various embodiments.

FIG. 1 illustrates an example of a MV for the current block C.

FIG. 2 illustrates an example of the prediction types.

FIG. 3 illustrates several fractional positions in the horizontal (x-) dimension.

FIG. 4 illustrates the spatial neighboring blocks: left (L), top (T), top-right (TR), left-bottom (LB) and top-left (TL).

FIG. 5 illustrates some examples (marked with NA1, NA2, and NA3) of non-adjacent spatial blocks.

FIG. 6 illustrates an example of a current block and its subblocks.

FIG. 7 illustrates a splitting line using an angle index (α) and a distance index (ρ).

FIG. 8 illustrates examples of different partitions in GPM.

FIG. 9 illustrates an example of GPM-MMVD where the 8 possible MVD direction is shown with dashed arrows.

FIG. 10 illustrates the GPM mode index 10 (with angle index of 4 and distance index of 0).

FIG. 11 illustrates an example for the template matching process for Part0 (when GPM mode index=10).

FIG. 12 illustrates an approach of applying the signaled MVD on top of the Bi-MV in GPM-MMVD according to an embodiment.

FIG. 13 illustrates an approach of applying the signaled MVD on top of the Bi-MV in GPM-MMVD according to an embodiment.

FIG. 14 illustrates step one of a proposed GPM-TM design with Bi-MV according to an embodiment.

FIG. 15 illustrates step two of a proposed GPM-TM design with Bi-MV according to an embodiment.

FIG. 16 illustrates step three of a proposed GPM-TM design with Bi-MV according to an embodiment.

FIG. 17 illustrates a flowchart according to an embodiment.

FIG. 18 is a block diagram of an apparatus according to an embodiment.

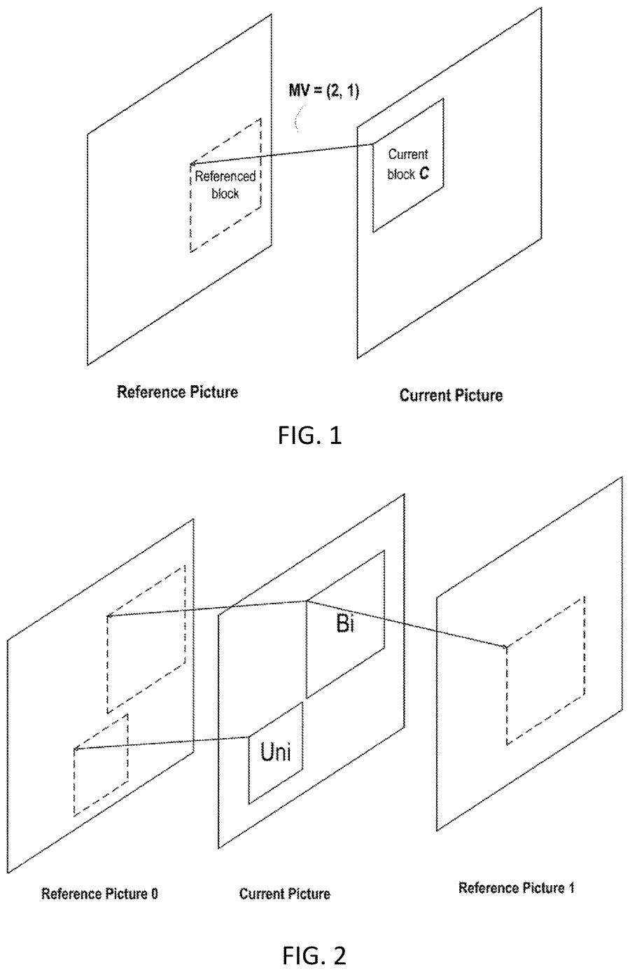

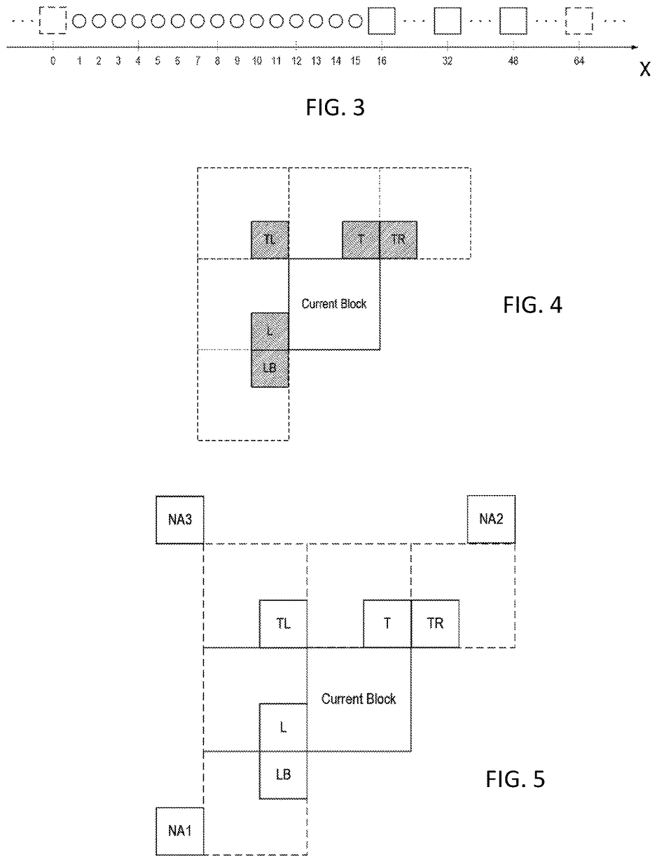

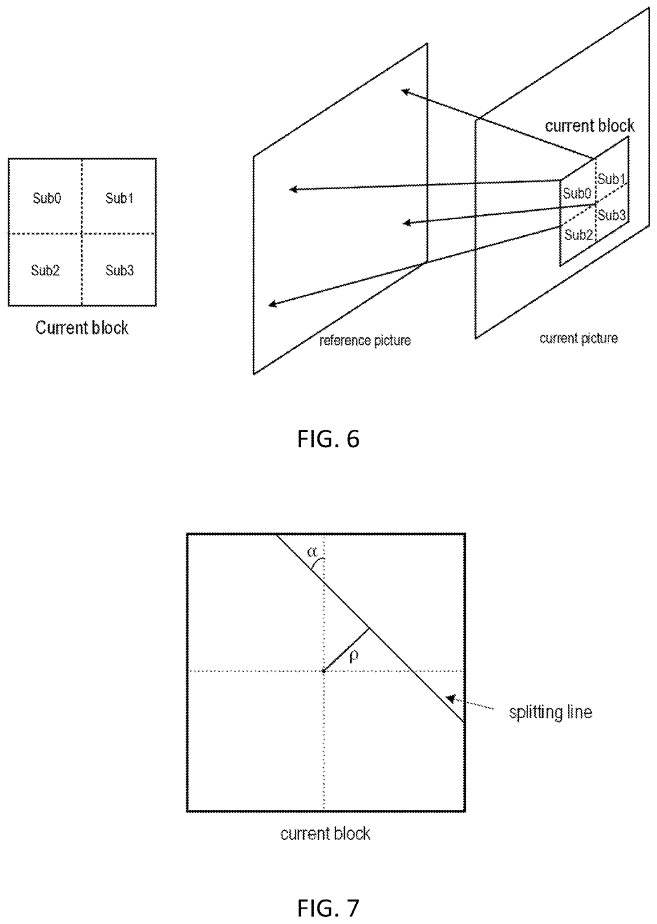

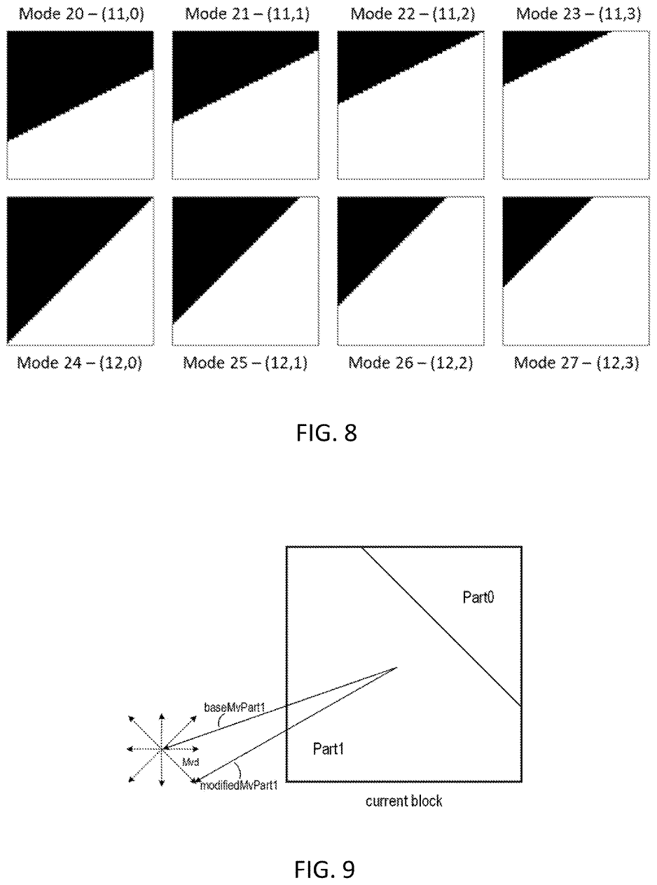

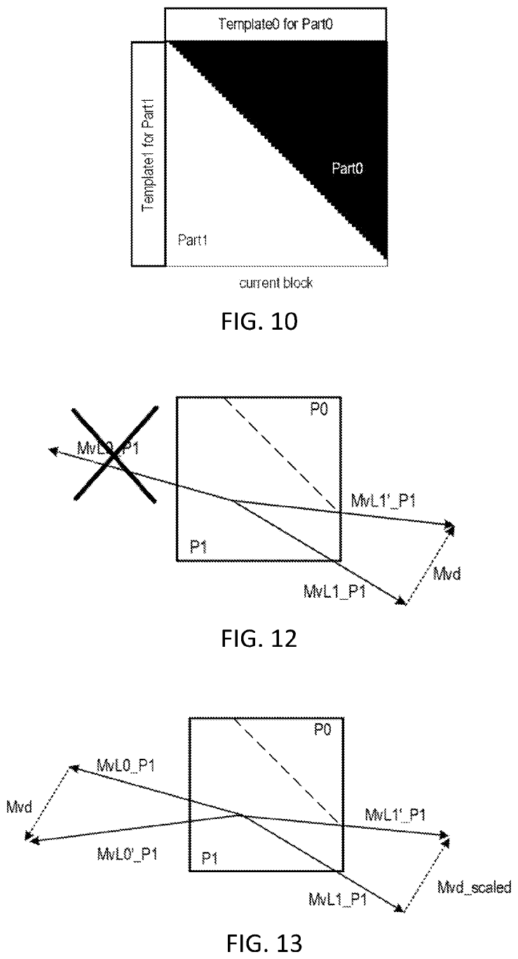

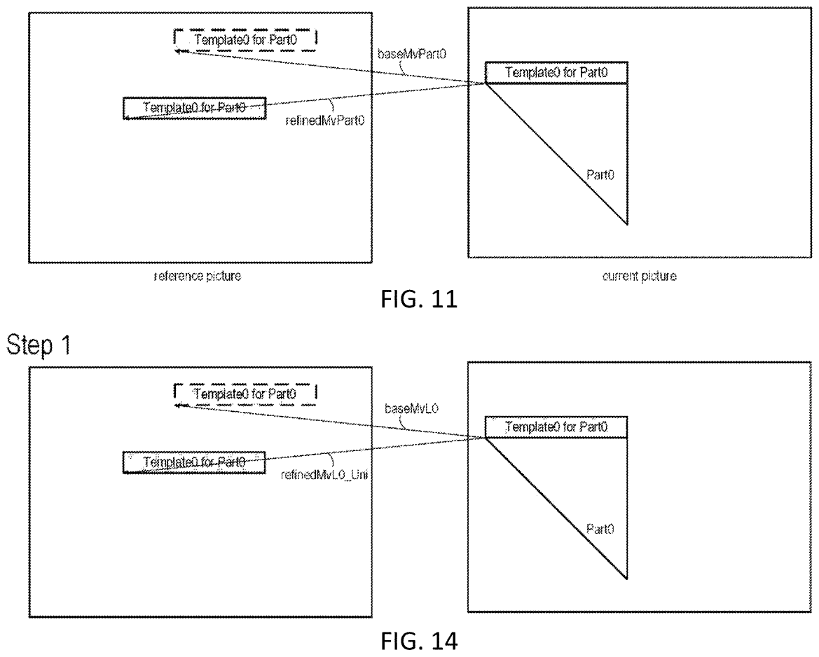

### DETAILED DESCRIPTION

The proposed method can be used in a video encoder or a video decoder to generate prediction samples of a block that coded using GPM.

Embodiments provide for at least four main features, which are described below as features A, B, C, and D.

Feature A. Modified the GPM motion information list generation process.

Variation A.a. The extraction process that converts the initial motion information list into a list of motion information containing only uni-MVs is modified to be conditionally invoked.

Variation A.a.a. In one alternative, when the current block is in a non-low-delay picture and has size smaller than 256 (e.g., 8×8, 8×16, and 16×8), the extraction process is invoked.

Variation A.a.b. In another alternative, when the current block has size smaller than 256 (e.g., 8×8, 8×16, and 16×8), the extraction process is invoked.

Otherwise, the extraction process is bypassed, and the initial motion information list is directly used as the GPM motion information list. In this case, when the previously decoded block uses Bi-MV for prediction and the Bi-MV is added into the initial list. The Bi-MV may be carried on into the GPM motion information list and further be used for at least one partition in GPM.

Variation A.b. When generating the initial motion information list, a different MV difference threshold may be used. The MV difference threshold controls whether a candidate is different enough (compared to those already added in the list) to be worthy of adding into the list. In other words, when the candidate's MV has a difference to the already added candidates that is below the MV difference threshold, the candidate is considered to be redundant and is not further added into the list.

In the existing design, the MV difference threshold is set to be 1 (in 1/16-pel precision).

Variation A.b.a. In one alternative, the MV difference threshold is made dependent on the current block size as well as the picture type (whether the picture is a low-delay picture or a non-low-delay picture). The following table shows exemplary settings.

| | Non-low-delay picture | Low-delay picture |
|---|---|---|
| Size < 256 | 1 | 8 (i.e., 8 in 1/16 pel |
| (Size = Width * | | precision, which is half-pel) |
| Height) | | |
| Size >= 256 | 16 (i.e., 16 in 1/16 pel | 16 (i.e., 16 in 1/16 pel |
| | precision, which is 1-pel) | precision, which is 1-pel) |

Variation A.b.b. In another alternative, the MV difference threshold is dependent on the current block size. The following table shows an example setting.

| | |
|---|---|
| Size < 256 | 1 |
| Where Size = Width * Height | |
| Size >= 256 | 16 (i.e., 16 in 1/16 pel |
| | precision, which is 1-pel) |

It should be noted that it is possible that in another alternative, the extraction process is always bypassed, i.e., the initial motion information list is always determined to be the final GPM motion information list.

Feature B. Extend the GPM-MMVD to incorporate with the Bi-MV as the base motion vector.

Two different approaches of applying the signaled MVD on top of the Bi-MV in GPM-MMVD are added.

The first approach is to switch the Bi-MV into a Uni-MV first, then apply the MVD on top of the Uni-MV.

FIG. 12 shows an example of this approach. As shown, the base Bi-MV contains two MVs, MvL0_P1 and MvL1_P1. When applying the MVD, the MV for L0 (MvL0_P1) is dropped first but the MV for L1 (MvL1_P1) is kept, the signaled MVD is then applied on top of the L1 MV to arrive at a new MV for L1 MvL1′_P1.

The corresponding index of the Bi-MV in the GPM motion information list determines which MV is to be dropped and which MV is to be kept. For example, when the index is dividable by 2, then the L0 MV of the Bi-MV is kept and the L1 MV of the Bi-MV is dropped. When the index is not dividable by 2, then the L1 MV of the Bi-MV is kept and the L0 Mv of the Bi-MV is dropped.

The second approach is to apply the MVD on top of one MV and apply a scaled version of the MVD on top of the other MV.

FIG. 13 shows an example of this approach. The signaled MVD is directly applied to the MvL0_P1 to arrive at a new MV for L0, MvL0′_P1. A scaled version of MVD Mvd_scaled is applied to the MvL1_P1 to arrive at a new MV for L1, MvL1′_P1.

The scaled version Mvd_scaled can be derived using the POC of current picture POC0, the POC of the reference picture L0 POC_L0, and the POC of the reference picture POC_L1.

The corresponding reference picture's absolute distance to the current picture determines which MV of the Bi_MV to have the MVD directly applied on its top. For example, when the corresponding reference picture of L0 MV has a larger absolute picture distance to the current picture than the corresponding reference picture of the L1 MV, then the MVD is directly applied on top of the L0 MV and the scaled MVD is applied on top of the L1 MV.

A scale value SC is derived based on the ratio between the POC distances for generating the scaled MVD. The scaled MVD Mvd_scaled (x_scaled, y_scaled) may be derived as: x_scaled=SC*x, and y_scaled=SC*y where x, and y are the components of the Mvd.

When it is the L1 MV to have the scaled MVD applied on its top, SC=(POC_L1−POC0)/(POCL0−POC0). Otherwise (when L0 MV to have the scaled MVD applied on its top), the scaled value SC may be derived as (POC_L0−POC0)/(POC_L1−POC0).

The switch between the first approach and the second approach may be made dependent on the picture coding type (whether the picture is a low-delay picture or a non-low-delay picture) and/or the magnitude of the MVD.

Variation B.a. In one example, when the picture is a non-low-delay picture, the first approach is used, otherwise (the picture is a low-delay picture), the second approach is used.

Variation B.b. In another example, when the picture is a non-low-delay picture and the signaled MVD exceeds a certain threshold (e.g., 4 in 1/16 precision, i.e., quarter-pel), the first approach is used. Otherwise, the second approach is used.

Feature C. Extend the GPM-TM to work with the Bi-MV.

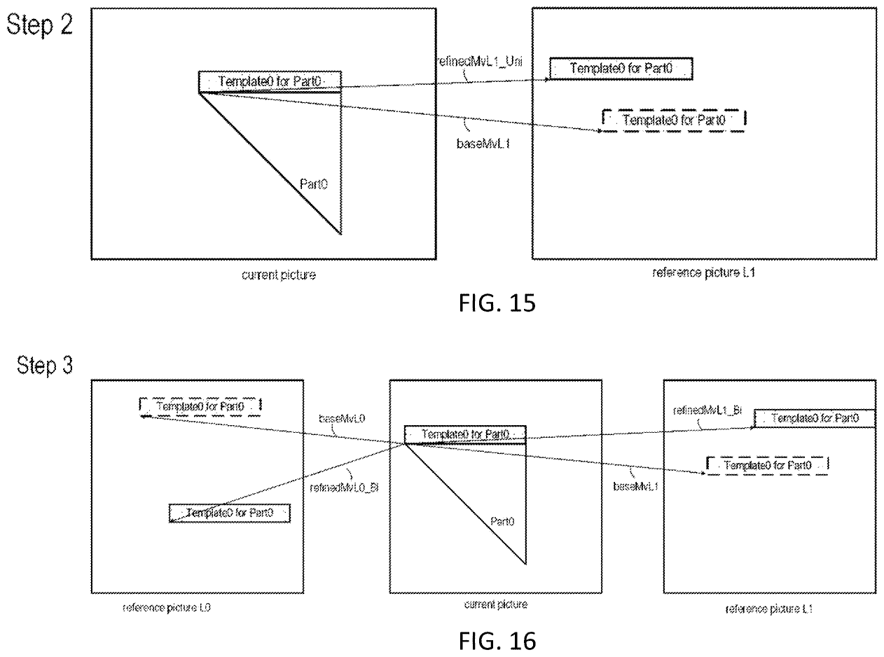

FIGS. 14-16 illustrate the three steps of a proposed GPM-TM design with Bi-MV in accordance with an embodiment.

The extended GPM-TM has following three steps.

Step 1 and Step 2 invoke uni-template matching to find the best refined Uni-MV for L0 and L1 respectively, i.e., refinedMvL0_Uni and refinedMvL1_Uni. And each refined Uni MV is associated with a uni-template cost, COST_UNI_L0 and COST_UNI_L1.

Step 3 invokes bi-template matching to find the best refined Bi-MV that resulted in the best matching (compares the current template and the combined template from L0 and L1). The resulted best refined Bi-MV is refinedMvL0_Bi and refinedMvL1_Bi. The best refined Bi-MV is also associated with a bi-template cost COST_BI.

For non-low-delay pictures, when the best template cost from using Bi-MV COST_BI exceeds 75% of the best template cost of Uni-MV (the minimum of COST_UNI_L0 and COST_UNI_L1), the best refined Uni-MV from the uni-template matching step (refinedMvL0_Uni or refinedMvL1_Uni depending on which gives smaller uni-template cost) may be used as the final refined MV for the partition. In other words, the refined motion information only contains one motion vector. Other thresholds are also possible.

For low-delay pictures, the refined Bi-MV (refinedMvL0_BI and refinedMvL1_BI) from the bi-template matching step is used as the final refined MV for the partition. In other words, the refined motion information keeps the number of motion vectors from the inherited MV.

For an inter GPM partition that is associated with a Bi-MV, after prediction samples are generated from the normal motion compensation, an 8×8 BDOF process is invoked to derive a MV refinement parameter (Vx, Vy) for each 8×8 block in the partition. The MV refinement parameter is further used to refine the prediction samples. Furthermore, the BDOF MV refinement parameter are stored on top of the Bi-MV in the motion storage buffer associated with the current partition, which can then be used for OBMC or predicting future inter blocks' MVs.

It can be noticed from the above features A-D that some of the criteria are based on the current picture coding type (whether the current picture is a low-delay picture or a non-low-delay picture). The motivation is that for non-low-delay pictures, it is more about providing more variants of MVs for prediction (i.e., provide easy flexibility of switching to use Uni-MV in a group of neighboring Bi-MVs). For low-delay pictures, it is more about keeping the Bi-MVs which can be valuable for future blocks (in low-delay picture, the inter prediction quality is generally low since the prediction always comes from the same direction, Bi-MV is more likely to be better as it at least can provide another hypothesis for the block than using Uni-MV, it is thus more important to keep the Bi-MV propagating to the future blocks).

The followings embodiments utilize one or more of these features. Embodiments 1-3 correspond to the feature A. Embodiments 4-8 correspond to feature B. Embodiments 9-10 correspond to the feature C. Embodiments 11-12 correspond to the feature D.

### Embodiment 1

For decoding a current block within a current picture inside a coded video bitstream, the decoder may implement the proposed method with at least one of the following steps:

The decoder may determine whether the current block is coded using GPM.

In response to determining that the current block is coded using GPM, the decoder may further determine whether at least one of its partitions is inter coded.

In response to determining that at least one partition (PX) is inter coded, the decoder may generate a GPM motion information list (LIST_FINAL). Generating this list may include generating an initial list of motion information (LIST_INIT) based on previously decoded blocks. Generating this list may further include determining whether to apply an extraction process to the initial motion information list (LIST_INIT) based on whether a first criterion C1 is fulfilled. When C1 is fulfilled, the output of the extraction process is determined to be LIST_FINAL. Otherwise, LIST_FINAL is directly determined to be LIST_INIT.

The decoder may further determine the motion information (MI_PX) associated with the partition (PX) based on the GPM motion information list (LIST_FINAL) and an index value (IDX). The index value (IDX) may be determined from the coded video bitstream.

The decoder may determine the prediction samples of the partition (PX) based on the associated motion information (MI_PX).

### Embodiment 2

This embodiment builds on Embodiment 1. The generation of the initial list LIST_INIT may further comprise using a MV difference value to control whether a candidate can be added into the list or not.

In one alternative, the MV difference value can be made based on the current block size as well as the current picture's coding type (whether the current picture is a low-delay picture or a non-low-delay picture). One example of the MV difference value is shown in the following table.

| | Non-low-delay picture | Low-delay picture |
|---|---|---|
| Size < 256 | 1 | 8 (i.e., 8 in 1/16 pel |
| (Size = Width * | | precision, which is half-pel) |
| Height) | | |
| Size >= 256 | 16 (i.e, 16 in 1/16 pel | 16 (i.e, 16 in 1/16 pel |
| | precision, which is 1-pel) | precision, which is 1-pel) |

In another alternative, the MV difference value is made based on the current block size. One example of the MV difference value is shown in the following table.

| | |
|---|---|
| Size < 256 | 1 |
| (Size = Width * Height) | |
| Size >= 256 | 16 (i.e., 16 in 1/16 pel |
| | precision, which is 1-pel) |

### Embodiment 3

This embodiment builds on any one of Embodiments 1 and 2. The criterion C1 may depend on the current block size and/or the current picture coding type (whether the current picture is a low-delay picture or a non-low-delay picture).

In one alternative, the criterion C1 is determined to be fulfilled when the current block size is below a threshold (for example, 256). In one alternative, the criterion C1 is determined to be fulfilled when the current block size is below a threshold (for example, 256) and the current picture is a non-low-delay picture.

### Embodiment 4

This embodiment builds on any one of Embodiments 1-3. The decoding step of determining the motion information (MI_PX) may comprise the following steps:

The decoder may determine whether a motion vector difference MVD information is present for the inter partition PX.

In response to determining that MVD information is present, the decoder may further determine the MVD.

The decoder may determine a base motion information (BASE_MI) based on the GPM motion information list LIST_FINAL and the index value IDX.

The decoder may determine a modified motion information (NEW_MI) based on the BASE_MI and MVD. This step may further comprise the following. When the BASE_MI contains more than one MV (i.e., Bi-MV: MV0, MV1), the decoder may further determine whether a second criterion C2 is fulfilled. In response to determining that the criterion C2 is fulfilled, the decoder may determine the modified motion information (NEW_MI) contains only one motion vector NEW_MV (i.e, Uni-MV, L0 or L1 MV), and derive the motion vector NEW_MV based on the corresponding MV of the Bi-MV and MVD. In other words, if NEW_MI contains only L0 MV, then the NEW_MV is determined based on MV0 of BASE_MI and MVD. If NEW_MI contains only L1 MV, then the NEW_MV is determined based on MV1 of BASE_MI and MVD. On the other hand, in response to determining that the criterion C2 is not fulfilled, the decoder may determine the modified motion information contains at least two motion vectors (NEW_MV0 and NEW_MV1), and derive the two motion vectors (NEW_MV0 and NEW_MV1) based on the two motion vectors MV0 and MV1 of the BASE_MI and the MVD.

### Embodiment 5

This embodiment builds on Embodiment 4. The criterion C2 may depend on the current picture coding type. The criterion C2 may be determined to be fulfilled when the current picture is a non-low-delay picture. Otherwise, when the current picture is a low-delay picture, the criterion C2 may be determined to be not fulfilled.

### Embodiment 6

This embodiment builds on Embodiment 5. The criterion C2 may further comprise determining whether the magnitude of the MVD exceeds a certain threshold.

In one example, the criterion C2 may be determined to be fulfilled when the magnitude of the motion vector difference's x or y component exceeds a quarter-pel distance.

### Embodiment 7

This embodiment builds on any one of Embodiments 4-6. When the criterion C2 is fulfilled, the modified motion information (NEW_MI) is determined to contain only L0 MV when the BASE_MI's associated index value (IDX) is dividable by 2. Otherwise (the associated index value (IDX) is not dividable by 2), the NEW_MI is determined to contain the L1 MV.

### Embodiment 8

This embodiment builds on any one of Embodiments 4-6. When the criterion C2 is not fulfilled, the determination of the two motion vectors NEW_MV0 and NEW_M1 may further comprise the following steps.

The decoder may determine a reference picture distance value for each of the MV0 and MV1 of the BASE_MI.

The decoder may determine the MVD to be applied on top of the MV that has a larger reference picture distance value.

The decoder may determine a scaled version of MVD, and apply the scaled MVD on top of the other MV (that has a smaller reference picture distance value).

### Embodiment 9

This embodiment builds on any one of Embodiments 1-8. The decoding step of determining the motion information (MI_PX) may further comprise the following steps.

The decoder may determine whether template matching refinement is enabled for the inter prediction PX.

The decoder may determine a base motion information (BASE_MI) based on the GPM motion information list (LIST_FINAL) and the index value (IDX).

The decoder may determine a refined motion information (TM_MI) based on BASE_MI and a template associated with the current block. The step may comprise the following. The decoder may determine whether the BASE_MI contains more than one MV (i.e., Bi-MV: MV0 and MV1). In response to determining that the BASE_MI contains more than one MV (MV0 and MV1), the decoder may do one or more of the following. The decoder may perform Uni template matching MV refinement for at least one of the MV (of BASE_MI) to find a best refined Uni-MV, NEW_MV0_UNI, and a best Uni-MV template cost, UNI_COST. The decoder may perform Bi template matching refinement based on both MV0 and MV1, to get refined NEW_MV0_BI and NEW_MV1_BI and a best Bi-MV template cost BI_COST. The decoder may determine whether the third criterion C3 is fulfilled. In response to determining that the third criterion C3 is fulfilled, the decoder may determine the refined motion information MI_PX to only contain one MV from the uni template matching, which is the refined NEW_MV0_UNI. On the other hand, in response to determining that the third criterion C3 is not fulfilled, the decoder may determine the refined motion information MI_PX to contain both refined MV0 and MV1 from the bi template matching, which are NEW_MV0_BI and NEW_MV1_BI.

### Embodiment 10

This embodiment builds on Embodiment 9. The third criterion C3 may be based on checking the current picture type and/or the best uni template cost UNI_COST and the best template cost BI_COST.

In one alternative, the third criterion C3 is determined to be fulfilled when the current picture is a non-low-delay picture and the BI_COST is larger than a ratio (preferably less than 1.0) of the UNI_COST. In one example, the ratio=0.75.

### Embodiment 11

This embodiment builds on any one of Embodiments 1-10. When the associated motion information MI_PX contains at least one MV, a refinement process may be further invoked to generate a pair of MV refinement parameters (Vx, Vy) for each of the N×N subblocks in the partition PX. The MV refinement parameters (Vx, Vy) may further be used to refine the prediction samples for the corresponding N×N subblock in the partition PX. Furthermore, the refinement parameters may be stored on top of the motion information MI_PX in the motion storage buffer associated with the partition.

### Embodiment 12

This embodiment builds on Embodiment 11. The refinement process may be a BDOF process. Furthermore, in one alternative, the dimension of the subblock N may be equal to 8.

### Embodiment 13

This embodiment builds on Embodiment 11. The refinement process may be a DMVR process.

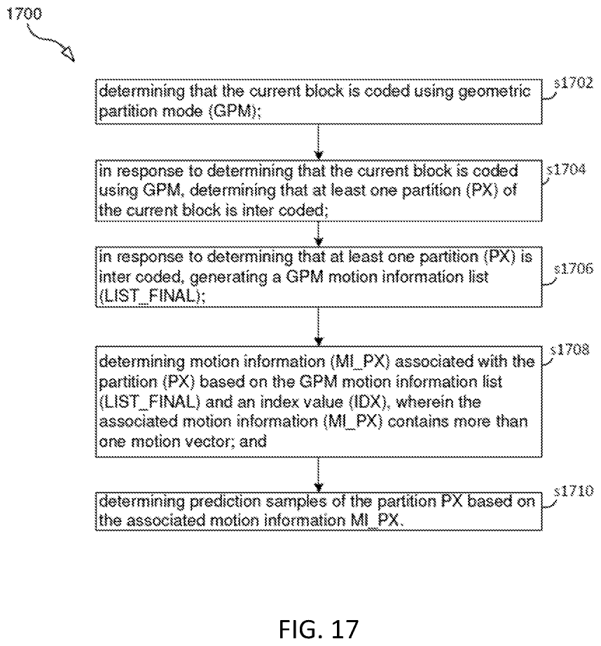

FIG. 17 is a flowchart illustrating a process 1700, according to an embodiment, for decoding a current block within a current picture inside a coded video bitstream. Process 1700 may begin in step s1702.

Step s1702 comprises determining that the current block is coded using geometric partition mode (GPM).

Step s1704 comprises, in response to determining that the current block is coded using GPM, determining that at least one partition (PX) of the current block is inter coded.

Step s1706 comprises, in response to determining that at least one partition (PX) is inter coded, generating a GPM motion information list (LIST_FINAL).

Step s1708 comprises determining motion information (MI_PX) associated with the partition (PX) based on the GPM motion information list (LIST_FINAL) and an index value (IDX). The associated motion information (MI_PX) contains more than one motion vector.

Step s1710 comprises determining prediction samples of the partition PX based on the associated motion information MI_PX.

In some embodiments, generating the GPM motion information list (LIST_FINAL) further comprises: (i) generating an initial motion information list (LIST_INIT) based on previously decoded blocks; (ii) determining whether to apply an extraction process to the initial motion information list (LIST_INIT) based on whether a first criterion (C1) is fulfilled, wherein the extraction process extracts motion information containing only one motion vector; and (iii) if the first criterion is fulfilled, performing the extraction process to the initial motion information list (LIST_INIT) and setting the GPM motion information list (LIST_FINAL) to be an output of the extraction process; and, if the first criterion is not fulfilled, setting the GPM motion information list (LIST_FINAL) to be the initial motion information list (LIST_INIT).

In some embodiments, generating the initial motion information list (LIST_INIT) based on previously decoded blocks comprises determining whether to add a candidate motion information to the initial motion information list (LIST_INIT) based on whether a difference between a motion vector of the candidate motion information and a motion vector of each of the motion information in the initial motion information list (LIST_INIT) is not smaller than a motion vector difference threshold value. In some embodiments, the motion vector difference threshold value is based on a size of the current block. In some embodiments, the motion vector difference threshold value is set as follows: If size<SIZE_TH, set the motion vector difference threshold value to MV_TH_A, otherwise, set the motion vector difference threshold value to MV_TH_B (MV_TH_B is greater than MV_TH_A) where size=W*H, for a width (W) of the current block and a height (H) of the current block. In some embodiments, the MV_TH_A is set to be 1 in 1/16-pel precision and the MV_TH_B is set to be 16 in 1/16-pel precision, and SIZE_TH is a size threshold. In some embodiments, the SIZE_TH is set to be 256.

In some embodiments, the motion vector difference threshold value is based on a picture coding type of the current picture. In some embodiments, the motion vector difference threshold value is set as follows: if (size)<256, and a picture coding type of the current picture is a non-low-delay picture, set the motion vector difference threshold value to 1; if (size)<256, and a picture coding type of the current picture is a low-delay picture, set the motion vector difference threshold value to 8; and if (size)≥256, set the motion vector difference threshold value to 16, where size=W*H, for a width (W) of the current block and a height (H) of the current block, and wherein the motion vector difference threshold is given in 1/16-pel precision.

In some embodiments, the first criterion (C1) is based on a size of the current block and/or picture coding type of the current picture. In some embodiments, the first criterion (C1) is fulfilled when the size of the current block is below a size threshold. In some embodiments, the first criterion (C1) is fulfilled when a size of the current block is below a size threshold and the current picture is a non-low-delay picture. In some embodiments, determining motion information (MI_PX) associated with the partition (PX) based on the GPM motion information list (LIST_FINAL) and the index value (IDX) comprises: determining that a motion vector difference (MVD) information is present for the partition (PX); in response to determining that the MVD information is present for the partition (PX), determining the MVD information; determining a base motion information (BASE_MI) based on the GPM motion information list (LIST_FINAL) and the index value IDX; and determining a modified motion information (NEW_MI) based on the base motion information (BASE_MI) and the MVD information.

In some embodiments, determining the modified motion information (NEW_MI) based on the base motion information (BASE_MI) and the MVD information comprises: determining that the modified motion information (NEW_MI) contains only one motion vector, either a L0 motion vector or a L1 motion vector; and deriving the modified motion information (NEW_MI) based on the corresponding motion vector of the base motion information (BASE_MI) and the MVD information, such that the modified motion information (NEW_MI) is determined based on the first motion vector (MV0) and the MVD information if the modified motion information (NEW_MI) is determined to contain the L0 motion vector, and the modified motion information (NEW_MI) is determined based on the second motion vector (MV1) and the MVD information if the modified motion information (NEW_MI) is determined to contain the L1 motion vector.

In some embodiments, determining the modified motion information (NEW_MI) based on the base motion information (BASE_MI) and the MVD information comprises: determining that the modified motion information (NEW_MI) contains at least a third motion vector (NEW_MV0) and a fourth motion vector (NEW_MV1); and deriving the third motion vector (NEW_MV0) based on the first motion vector (MV0) and the MVD information, and deriving the fourth motion vector (NEW_MV1) based on the second motion vector (MV1) and the MVD information.

In some embodiments, determining the modified motion information (NEW_MI) based on the base motion information (BASE_MI) and the MVD information comprises: determining whether a second criterion (C2) is fulfilled, wherein the base motion information (BASE_MI) contains at least a first motion vector (MV0) and a second motion vector (MV1); if the second criterion (C2) is fulfilled, (i) determining that the modified motion information (NEW_MI) contains only one motion vector, either a L0 motion vector or a L1 motion vector; (ii) deriving the modified motion information (NEW_MI) based on the corresponding motion vector of the base motion information (BASE_MI) and the MVD information, such that the modified motion information (NEW_MI) is determined based on the first motion vector (MV0) and the MVD information if the modified motion information (NEW_MI) is determined to contain the L0 motion vector, and the modified motion information (NEW_MI) is determined based on the second motion vector (MV1) and the MVD information if the modified motion information (NEW_MI) is determined to contain the L1 motion vector; and if the second criterion (C2) is not fulfilled, (i) determining that the modified motion information (NEW_MI) contains at least a third motion vector (NEW_MV0) and a fourth motion vector (NEW_MV1), (ii) deriving the third motion vector (NEW_MV0) based on the first motion vector (MV0) and the MVD information, and (iii) deriving the fourth motion vector (NEW_MV1) based on the second motion vector (MV1) and the MVD information.

In some embodiments, the second criterion (C2) is based on a picture coding type of the current picture. In some embodiments, the second criterion (C2) is fulfilled when the current picture is a non-low-delay picture and the second criterion (C2) is not fulfilled when the current picture is a low-delay picture. In some embodiments, the second criterion (C2) is further based on whether a magnitude of the MVD information exceeds an MVD threshold. In some embodiments, the second criterion (C2) is fulfilled when the magnitude of the MVD information exceeds a quarter-pel distance in an x-component or y-component. In some embodiments, when the second criterion (C2) is fulfilled, the modified motion information (NEW_MI) is determined to contain only the L0 motion vector when an associated index value (IDX) of the base motion information (BASE_MI) is divisible by 2, and otherwise the modified motion information (NEW_MI) is determined to contain only the L1 motion vector.

In some embodiments, when the second criterion (C2) is not fulfilled, the steps (ii) deriving the third motion vector (NEW_MV0) based on the first motion vector (MV0) and the MVD information, and (iii) deriving the fourth motion vector (NEW_MV1) based on the second motion vector (MV1) and the MVD information further comprise: determining a reference picture distance value for each of the first motion vector (MV0) and the second motion vector (MV1); determining the MVD information to be applied on top of the motion vector having a larger reference picture distance value of the first motion vector (MV0) and the second motion vector (MV1); determining a scaled version of the MVD information; and applying the scaled version of the MVD information on top of the motion vector having a smaller reference picture distance value of the first motion vector (MV0) and the second motion vector (MV1).

In some embodiments, determining motion information (MI_PX) associated with the partition (PX) based on the GPM motion information list (LIST_FINAL) and an index value (IDX) comprises: determining that template matching refinement is enabled for the partition (PX); determining a base motion information (BASE_MI) based on the GPM motion information list (LIST_FINAL) and the index value (IDX); determining a refined motion information (TM_MI) based on the base motion information (BASE_MI) and a template associated with the current block. In some embodiments, determining a refined motion information (TM_MI) based on the base motion information (BASE_MI) and a template associated with the current block comprises: determining that the base motion information (BASE_MI) contains at least a first motion vector (MV0) and a second motion vector (MV1); performing uni-template matching motion vector refinement for at least one of the first motion vector (MV0) and the second motion vector (MV1) to find a refined uni-motion vector (NEW_MV0_UNI) and a uni-motion-vector template cost (UNI_COST); performing bi-template matching refinement based on both the first motion vector (MV0) and the second motion vector (MV1) to get a refined first motion vector (NEW_MV0_BI) and a refined second motion vector (NEW_MV1_BI) and a bi-motion-vector template cost (BI_COST); determining whether a third criterion (C3) is fulfilled; if the third criterion (C3) is fulfilled, determining refined motion information (MI_PX) to only contain one motion vector from the uni-template matching (NEW_MV0_UNI); and if the third criterion (C3) is not fulfilled, determining refined motion information (MI_PX) to contain both refined first motion vector (NEW_MV0_BI) and refined second motion vector (NEW_MV1_BI) from the bi-template matching.

In some embodiments, the third criterion (C3) is based on checking a picture type of the current picture and checking the uni-template cost (UNI_COST) and the bi-template cost (BI_COST). In some embodiments, the third criterion (C3) is fulfilled when the current picture is a non-low-delay picture and the bi-template cost (BI_COST) is larger than a cost threshold and otherwise the third criterion (C3) is not fulfilled, wherein the cost threshold is a function of the uni-template cost (UNI_COST). In some embodiments, the method further comprises invoking a refinement process, when the associated motion information (MI_PX) contains at least one motion vector, to generate a pair of motion vector refinement parameters (Vx, Vy) for each N×N subblock in the partition (PX); and using the motion vector refinement parameters (Vx, Vy) to refine the prediction samples for the corresponding N×N subblock in the partition PX. In some embodiments, the refinement process is a bi-directional optimal flow (BDOF) process. In some embodiments, the refinement process is a decoder-side motion vector refinement (DMVR) process.

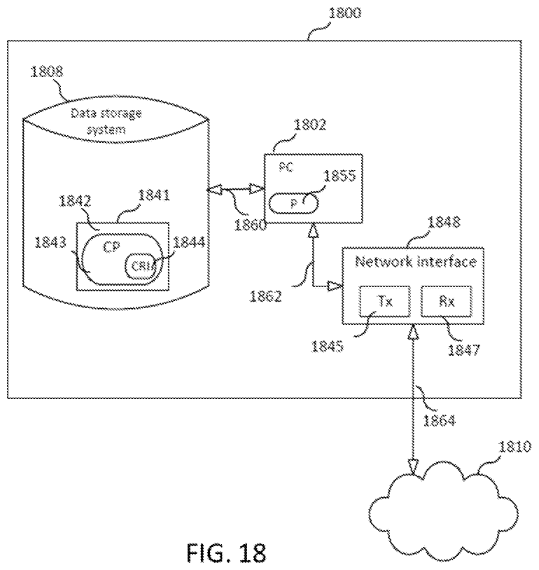

FIG. 18 is a block diagram of apparatus 1800 (e.g., an encoder or decoder), according to some embodiments, for performing the methods disclosed herein. As shown in FIG. 18, apparatus 1800 may comprise: processing circuitry (PC) 1802, which may include one or more processors (P) 1855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1800 may be a distributed computing apparatus); at least one network interface 1848 comprising a transmitter (Tx) 1845 and a receiver (Rx) 1847 for enabling apparatus 1800 to transmit data to and receive data from other nodes connected to a network 1810 (e.g., an Internet Protocol (IP) network) to which network interface 1848 is connected (directly or indirectly) (e.g., network interface 1848 may be wirelessly connected to the network 1810, in which case network interface 1848 is connected to an antenna arrangement); and a storage unit (a.k.a., “data storage system”) 1808, which may include one or more non-volatile storage devices and/or one or more volatile storage devices. Interface 1860 may connect PC 1802 and storage unit 1808, interface 1862 may connect PC 1802 and network interface 1848, and interface 1864 may connect network interface 1848 and network 1810. In embodiments where PC 1802 includes a programmable processor, a computer program product (CPP) 1141 may be provided. CPP 1841 includes a computer readable medium (CRM) 1842 storing a computer program (CP) 1843 comprising computer readable instructions (CRI) 1844. CRM 1842 may be a non-transitory computer readable medium, such as, magnetic media (e.g., a hard disk), optical media, memory devices (e.g., random access memory, flash memory), and the like. In some embodiments, the CRI 1844 of computer program 1143 is configured such that when executed by PC 1802, the CRI causes apparatus 1800 to perform steps described herein (e.g., steps described herein with reference to the flow charts). In other embodiments, apparatus 1800 may be configured to perform steps described herein without the need for code. That is, for example, PC 1802 may consist merely of one or more ASICs. Hence, the features of the embodiments described herein may be implemented in hardware and/or software.

One embodiment has been implemented in the current ECM (i.e., ECM-8.0). The following table shows the objective performance of this embodiment (incorporating features A.a.a, A.b.a, B.a, C, and D) compared to ECM-8.0 (under the ECM random access and low delay common test configuration). The numbers in the table show the relative bit-cost for the embodiment to achieve equivalent objective video quality (measured in PSNR) as ECM-8.0. The BD-rate number −0.X % means the proposed solution requires 0.X % less bits than ECM-8.0 for the same objective quality for different classes of video sequences. The EncT/DecT show the encoding and decoding run time measurement respectively, where a number of 100% means the test and anchor has the same amount of run time.

Random Access Main 10
Over ECM-8.0

| | Y | U | V | EncT | DecT |
|---|---|---|---|---|---|
| Class A1 | −0.19% | −0.12% | −0.09% | | 101% |
| Class A2 | −0.26% | −0.16% | −0.10% | | 100% |
| Class B | −0.19% | −0.22% | −0.30% | | 100% |
| Class C | −0.19% | −0.14% | −0.10% | 101% | 99% |
| Class E | | | | | |
| Overall | −0.20% | −0.17% | −0.16% | | 100% |
| Class D | −0.13% | 0.10% | −0.07% | 101% | 100% |
| Class F | −0.11% | −0.15% | −0.15% | | 100% |
| Class TGM | 0.01% | −0.05% | −0.02% | | 101% |

Low delay B Main10
Over ECM-8.0

| | Y | U | V | EncT | DecT |
|---|---|---|---|---|---|
| Class A1 | | | | | |
| Class A2 | | | | | |
| Class B | −0.25% | −0.48% | −0.47% | | |
| Class C | −0.35% | −0.43% | −0.56% | | 102% |
| Class E | −0.31% | 0.34% | −0.22% | | 101% |
| Overall | −0.30% | −0.26% | −0.44% | | |
| Class D | −0.04% | −0.60% | −0.64% | 102% | 102% |
| Class F | −0.03% | −0.05% | −0.12% | | 100% |
| Class TGM | 0.01% | 0.03% | −0.01% | | 98% |

As can be noticed from the table, the embodiment provides −0.2% bit reduction for Random Access with 1% encoding time increase and no decoding time increase, and −0.30% bit rate reduction for Low delay with 2% encoding time and 1-2% decoding time increase. It is asserted that such a tradeoff between bit reduction and enc/dec run time impact is reasonable.

Another embodiment (incorporating features A.a.a, A.b.a, B.b, C, and D) is also implemented and tested. The objective numbers compared to ECM-8.0 under Random access configuration are shown below. Based on the numbers, feature B.b may be a better alternative than B.a in terms of bit reduction.

Random Access Main 10
Over ECM-8.0

| | Y | U | V | EncT | DecT |
|---|---|---|---|---|---|
| Class A1 | −0.19% | −0.16% | −0.22% | | |
| Class A2 | −0.27% | −0.10% | −0.07% | | |
| Class B | −0.19% | −0.15% | −0.22% | | |
| Class C | −0.20% | −0.18% | −0.13% | | |
| Class E | | | | | |
| Overall | −0.21% | −0.15% | −0.17% | | |
| Class D | −0.16% | 0.18% | −0.12% | | |
| Class F | −0.10% | −0.14% | −0.13% | | |

Yet another embodiment (incorporating features A.a.b, A.b.b, B.a, C, and D) is also implemented and tested. The objective numbers compared to ECM-8.0 under random access and low delay configuration are show below. This version has lower complexity comparing to the versions above, since the version uses uni motion vectors for small blocks (for all pictures) and only uses bi motion vectors for larger blocks.

Random Access Main 10
Over ECM-8.0

| | Y | U | V | EncT | DecT |
|---|---|---|---|---|---|
| Class A1 | | | | | |
| Class A2 | −0.28% | −0.24% | −0.17% | | |
| Class B | −0.18% | −0.11% | −0.21% | 101% | 99% |
| Class C | −0.22% | −0.22% | −0.06% | 101% | 100% |
| Class E | | | | | |
| Overall | | | | | |
| Class D | −0.15% | 0.08% | −0.05% | 101% | 100% |
| Class F | −0.13% | −0.20% | −0.18% | | |
| Class | | | | | |
| TGM | | | | | |

Low delay B Main10
Over ECM-8.0

| | Y | U | V | EncT | DecT |
|---|---|---|---|---|---|
| Class A1 | | | | | |
| Class A2 | | | | | |
| Class B | −0.23% | −0.55% | −0.27% | | 100% |
| Class C | −0.30% | −0.08% | −0.02% | 102% | 102% |
| Class E | −0.30% | 0.31% | −0.01% | 102% | 101% |
| Overall | −0.27% | −0.18% | −0.12% | | 101% |
| Class D | −0.08% | −0.47% | −0.50% | 101% | 102% |
| Class F | 0.11% | −0.33% | −0.03% | | 102% |
| Class | | | | | |
| TGM | | | | | |

### Concise Description of Certain Embodiments

A1. A method for decoding a current block within a current picture inside a coded video bitstream, the method comprising:
determining that the current block is coded using geometric partition mode (GPM);
in response to determining that the current block is coded using GPM, determining that at least one partition (PX) of the current block is inter coded;
in response to determining that at least one partition (PX) is inter coded, generating a GPM motion information list (LIST_FINAL);
determining motion information (MI_PX) associated with the partition (PX) based on the GPM motion information list (LIST_FINAL) and an index value (IDX), wherein the associated motion information (MI_PX) contains more than one motion vector; and
determining prediction samples of the partition PX based on the associated motion information MI_PX.

A2. The method of claim A1, wherein generating the GPM motion information list (LIST_FINAL) further comprises:
(i) generating an initial motion information list (LIST_INIT) based on previously decoded blocks;
(ii) determining whether to apply an extraction process to the initial motion information list (LIST_INIT) based on whether a first criterion (C1) is fulfilled, wherein the extraction process extracts motion information containing only one motion vector; and
(iii) if the first criterion is fulfilled, performing the extraction process to the initial motion information list (LIST_INIT) and setting the GPM motion information list (LIST_FINAL) to be an output of the extraction process; and, if the first criterion is not fulfilled, setting the GPM motion information list (LIST_FINAL) to be the initial motion information list (LIST_INIT).

A3. The method of any one of claims A1-A2, wherein generating the initial motion information list (LIST_INIT) based on previously decoded blocks comprises determining whether to add a candidate motion information to the initial motion information list (LIST_INIT) based on whether a difference between a motion vector of the candidate motion information and a motion vector of each of the motion information in the initial motion information list (LIST_INIT) is not smaller than a motion vector difference threshold value.

A4. The method of claim A3, wherein the motion vector difference threshold value is based on a size of the current block.

A5. The method of claim A3-A4, wherein the motion vector difference threshold value is set as follows:
If size<SIZE_TH, set the motion vector difference threshold value to 1, otherwise, set the motion vector difference threshold value to 16,
where size=W*H, for a width (W) of the current block and a height (H) of the current block, and wherein the motion vector difference threshold is given in 1/16-pel precision, and SIZE_TH is a size threshold.

A6. The method of claim A3-A5, wherein the motion vector difference threshold value is based on a picture coding type of the current picture.

A7. The method claims of any one of claims A3-A6, wherein the motion vector difference threshold value is set as follows:
if (size)<256, and a picture coding type of the current picture is a non-low-delay picture, set the motion vector difference threshold value to 1;
if (size)<256, and a picture coding type of the current picture is a low-delay picture, set the motion vector difference threshold value to 8; and
if (size)≥256, set the motion vector difference threshold value to 16,
where size=W*H, for a width (W) of the current block and a height (H) of the current block, and wherein the motion vector difference threshold is given in 1/16-pel precision.

A8. The method of any one of claims A1-A7, wherein the first criterion (C1) is based on a size of the current block and/or picture coding type of the current picture.

A9. The method of any one of claims A1-A8, wherein the first criterion (C1) is fulfilled when a size of the current block is below a size threshold and the current picture is a non-low-delay picture.

A10. The method of any one of claims A1-A9, wherein determining motion information (MI_PX) associated with the partition (PX) based on the GPM motion information list (LIST_FINAL) and the index value (IDX) comprises:
determining that a motion vector difference (MVD) information is present for the partition (PX);
in response to determining that the MVD information is present for the partition (PX), determining the MVD information;
determining a base motion information (BASE_MI) based on the GPM motion information list (LIST_FINAL) and the index value IDX; and
determining a modified motion information (NEW_MI) based on the base motion information (BASE_MI) and the MVD information.

A11. The method of claim A10, wherein determining the modified motion information (NEW_MI) based on the base motion information (BASE_MI) and the MVD information comprises:
determining that the modified motion information (NEW_MI) contains only one motion vector, either a L0 motion vector or a L1 motion vector; and
deriving the modified motion information (NEW_MI) based on the corresponding motion vector of the base motion information (BASE_MI) and the MVD information, such that the modified motion information (NEW_MI) is determined based on the first motion vector (MV0) and the MVD information if the modified motion information (NEW_MI) is determined to contain the L0 motion vector, and the modified motion information (NEW_MI) is determined based on the second motion vector (MV1) and the MVD information if the modified motion information (NEW_MI) is determined to contain the L1 motion vector.

A12. The method of claim A10, wherein determining the modified motion information (NEW_MI) based on the base motion information (BASE_MI) and the MVD information comprises:
determining that the modified motion information (NEW_MI) contains at least a third motion vector (NEW_MV0) and a fourth motion vector (NEW_MV1); and
deriving the third motion vector (NEW_MV0) based on the first motion vector (MV0) and the MVD information, and deriving the fourth motion vector (NEW_MV1) based on the second motion vector (MV1) and the MVD information.

A13. The method of claim A10, wherein determining the modified motion information (NEW_MI) based on the base motion information (BASE_MI) and the MVD information comprises:
determining whether a second criterion (C2) is fulfilled, wherein the base motion information (BASE_MI) contains at least a first motion vector (MV0) and a second motion vector (MV1);
if the second criterion (C2) is fulfilled, (i) determining that the modified motion information (NEW_MI) contains only one motion vector, either a L0 motion vector or a L1 motion vector; (ii) deriving the modified motion information (NEW_MI) based on the corresponding motion vector of the base motion information (BASE_MI) and the MVD information, such that the modified motion information (NEW_MI) is determined based on the first motion vector (MV0) and the MVD information if the modified motion information (NEW_MI) is determined to contain the L0 motion vector, and the modified motion information (NEW_MI) is determined based on the second motion vector (MV1) and the MVD information if the modified motion information (NEW_MI) is determined to contain the L1 motion vector; and
if the second criterion (C2) is not fulfilled, (i) determining that the modified motion information (NEW_MI) contains at least a third motion vector (NEW_MV0) and a fourth motion vector (NEW_MV1), (ii) deriving the third motion vector (NEW_MV0) based on the first motion vector (MV0) and the MVD information, and (iii) deriving the fourth motion vector (NEW_MV1) based on the second motion vector (MV1) and the MVD information.

A14. The method of claim A13, wherein the second criterion (C2) is based on a picture coding type of the current picture.

A15. The method of claim A14, wherein the second criterion (C2) is fulfilled when the current picture is a non-low-delay picture and the second criterion (C2) is not fulfilled when the current picture is a low-delay picture.

A16. The method of any one of claims A13-A15, wherein the second criterion (C2) is further based on whether a magnitude of the MVD information exceeds an MVD threshold.

A17. The method of claims A16, wherein the second criterion (C2) is fulfilled when the magnitude of the MVD information exceeds a quarter-pel distance in an x-component or y-component.

A18. The method of any one of claims A13-A17, wherein, when the second criterion (C2) is fulfilled, the modified motion information (NEW_MI) is determined to contain only the L0 motion vector when an associated index value (IDX) of the base motion information (BASE_MI) is divisible by 2, and otherwise the modified motion information (NEW_MI) is determined to contain only the L1 motion vector.

A19. The method of any one of claims A13-A17, wherein, when the second criterion (C2) is not fulfilled, the steps (ii) deriving the third motion vector (NEW_MV0) based on the first motion vector (MV0) and the MVD information, and (iii) deriving the fourth motion vector (NEW_MV1) based on the second motion vector (MV1) and the MVD information further comprise:
determining a reference picture distance value for each of the first motion vector (MV0) and the second motion vector (MV1);
determining the MVD information to be applied on top of the motion vector having a larger reference picture distance value of the first motion vector (MV0) and the second motion vector (MV1);
determining a scaled version of the MVD information; and
applying the scaled version of the MVD information on top of the motion vector having a smaller reference picture distance value of the first motion vector (MV0) and the second motion vector (MV1).

A20. The method of any one of claims A1-A19, wherein determining motion information (MI_PX) associated with the partition (PX) based on the GPM motion information list (LIST_FINAL) and an index value (IDX) comprises:
determining that template matching refinement is enabled for the partition (PX);
determining a base motion information (BASE_MI) based on the GPM motion information list (LIST_FINAL) and the index value (IDX);
determining a refined motion information (TM_MI) based on the base motion information (BASE_MI) and a template associated with the current block.

A21. The method of claim A20, wherein determining a refined motion information (TM_MI) based on the base motion information (BASE_MI) and a template associated with the current block comprises:
determining that the base motion information (BASE_MI) contains at least a first motion vector (MV0) and a second motion vector (MV1);
performing uni-template matching motion vector refinement for at least one of the first motion vector (MV0) and the second motion vector (MV1) to find a refined uni-motion vector (NEW_MV0_UNI) and a uni-motion-vector template cost (UNI_COST);
performing bi-template matching refinement based on both the first motion vector (MV0) and the second motion vector (MV1) to get a refined first motion vector (NEW_MV0_BI) and a refined second motion vector (NEW_MV1_BI) and a bi-motion-vector template cost (BI_COST);
determining whether a third criterion (C3) is fulfilled;
if the third criterion (C3) is fulfilled, determining refined motion information (MI_PX) to only contain one motion vector from the uni-template matching (NEW_MV0_UNI); and
if the third criterion (C3) is not fulfilled, determining refined motion information (MI_PX) to contain both refined first motion vector (NEW_MV0_BI) and refined second motion vector (NEW_MV1_BI) from the bi-template matching.

A22. The method of claim A21, wherein the third criterion (C3) is based on checking a picture type of the current picture and checking the uni-template cost (UNI_COST) and the bi-template cost (BI_COST).

A23. The method of claim A21, wherein the third criterion (C3) is fulfilled when the current picture is a non-low-delay picture and the bi-template cost (BI_COST) is larger than a cost threshold and otherwise the third criterion (C3) is not fulfilled, wherein the cost threshold is a function of the uni-template cost (UNI_COST).

A24. The method of any one of claims A1-A23, further comprising:
invoking a refinement process, when the associated motion information (MI_PX) contains at least one motion vector, to generate a pair of motion vector refinement parameters (Vx, Vy) for each N×N subblock in the partition (PX); and
using the motion vector refinement parameters (Vx, Vy) to refine the prediction samples for the corresponding N×N subblock in the partition PX.

A25. The method of claim A24, wherein the refinement process is a bi-directional optimal flow (BDOF) process.

A26. The method of claim A24, wherein the refinement process is a decoder-side motion vector refinement (DMVR) process.

B1. A decoder comprising:
processing circuitry (1802); and
a memory, the memory containing instructions (1844) executable by the processing circuitry (1802), whereby when executed the processing circuitry (1802) is configured to:
determine that the current block is coded using geometric partition mode (GPM);
in response to determining that the current block is coded using GPM, determine that at least one partition (PX) of the current block is inter coded;
in response to determining that at least one partition (PX) is inter coded, generate a GPM motion information list (LIST_FINAL);
determine motion information (MI_PX) associated with the partition (PX) based on the GPM motion information list (LIST_FINAL) and an index value (IDX), wherein the associated motion information (MI_PX) contains more than one motion vector; and
determine prediction samples of the partition PX based on the associated motion information MI_PX.

B2. The decoder of claim B1, wherein the processing circuitry (1802) is further configured to perform the steps of any one of claims A2-A26.

C1. A decoder adapted to:
determine that the current block is coded using geometric partition mode (GPM);
in response to determining that the current block is coded using GPM, determine that at least one partition (PX) of the current block is inter coded;
in response to determining that at least one partition (PX) is inter coded, generate a GPM motion information list (LIST_FINAL);
determine motion information (MI_PX) associated with the partition (PX) based on the GPM motion information list (LIST_FINAL) and an index value (IDX), wherein the associated motion information (MI_PX) contains more than one motion vector; and
determine prediction samples of the partition PX based on the associated motion information MI_PX.

C2. The decoder of claim C1, further adapted to perform the steps of any one of claims A2-A26.

D1. A computer program (1843) comprising instructions which when executed by processing circuitry (1802) of a node (1800), causes the node (1800) to perform the method of any one of embodiments A1-A26.

D2. A carrier containing the computer program (1843) of embodiment D1, wherein the carrier is one of an electronic signal, an optical signal, a radio signal, and a computer readable storage medium (1842).

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-29. (canceled)

30. A method for decoding a current block within a current picture inside a coded video bitstream, the method comprising:
determining that the current block is coded using geometric partition mode (GPM);
in response to determining that the current block is coded using GPM, determining that at least one partition, PX, of the current block is inter coded;
in response to determining that at least one partition, PX, is inter coded, generating a GPM motion information list, LIST_FINAL;
determining motion information, MI_PX, associated with the partition, PX, based on the GPM motion information list, LIST_FINAL, and an index value, IDX, wherein the associated motion information, MI_PX, contains more than one motion vector; and
determining prediction samples of the partition PX based on the associated motion information MI_PX,
wherein generating the GPM motion information list, LIST_FINAL, further comprises:
generating an initial motion information list, LIST_INIT, based on previously decoded blocks;
determining whether to apply an extraction process to the initial motion information list, LIST_INIT, based on whether a first criterion, C1, is fulfilled, wherein the extraction process extracts motion information containing only one motion vector; and
if the first criterion is fulfilled, performing the extraction process to the initial motion information list, LIST_INIT, and setting the GPM motion information list, LIST_FINAL, to be an output of the extraction process; and, if the first criterion is not fulfilled, setting the GPM motion information list, LIST_FINAL, to be the initial motion information list, LIST_INIT.

31. The method of claim 30, wherein generating the initial motion information list, LIST_INIT, based on previously decoded blocks comprises determining whether to add a candidate motion information to the initial motion information list, LIST_INIT, based on whether a difference between a motion vector of the candidate motion information and a motion vector of each of the motion information in the initial motion information list, LIST_INIT, is not smaller than a motion vector difference threshold value.

32. The method of claim 31, wherein the motion vector difference threshold value is based on a size of the current block.

33. The method of claim 31, wherein the motion vector difference threshold value is set as follows:
If size<SIZE_TH, set the motion vector difference threshold value to 1, otherwise, set the motion vector difference threshold value to 16,
where size=W*H, for a width, W, of the current block and a height, H, of the current block, and wherein the motion vector difference threshold is given in 1/16-pel precision, and SIZE_TH is a size threshold.

34. The method of claim 31, wherein the motion vector difference threshold value is based on a picture coding type of the current picture.

35. The method of claim 31, wherein the motion vector difference threshold value is set as follows:
if size<256, and a picture coding type of the current picture is a non-low-delay picture, set the motion vector difference threshold value to 1;
if size<256, and a picture coding type of the current picture is a low-delay picture, set the motion vector difference threshold value to 8; and
if size≥256, set the motion vector difference threshold value to 16,
where size=W*H, for a width, W, of the current block and a height, H, of the current block, and wherein the motion vector difference threshold is given in 1/16-pel precision.

36. The method of claim 30, wherein the first criterion, C1, is based on a size of the current block and/or picture coding type of the current picture.

37. The method of claim 30, wherein the first criterion, C1, is fulfilled when a size of the current block is below a size threshold and the current picture is a non-low-delay picture.

38. The method of claim 30, wherein determining motion information, MI_PX, associated with the partition, PX, based on the GPM motion information list, LIST_FINAL, and the index value, IDX, comprises:
determining that a motion vector difference, MVD, information is present for the partition, PX;
in response to determining that the MVD information is present for the partition, PX, determining the MVD information;
determining a base motion information, BASE_MI, based on the GPM motion information list, LIST_FINAL, and the index value IDX; and
determining a modified motion information, NEW_MI, based on the base motion information, BASE_MI, and the MVD information.

39. The method of claim 38, wherein determining the modified motion information, NEW_MI, based on the base motion information, BASE_MI, and the MVD information comprises:
determining that the modified motion information, NEW_MI, contains only one motion vector, either a L0 motion vector or a L1 motion vector; and
deriving the modified motion information, NEW_MI, based on the corresponding motion vector of the base motion information, BASE_MI, and the MVD information, such that the modified motion information, NEW_MI, is determined based on the first motion vector, MV0, and the MVD information if the modified motion information, NEW_MI, is determined to contain the L0 motion vector, and the modified motion information, NEW_MI, is determined based on the second motion vector, MV1, and the MVD information if the modified motion information, NEW_MI, is determined to contain the L1 motion vector.

40. The method of claim 38, wherein determining the modified motion information, NEW_MI, based on the base motion information, BASE_MI, and the MVD information comprises:
determining that the modified motion information, NEW_MI, contains at least a third motion vector, NEW_MV0, and a fourth motion vector, NEW_MV1; and
deriving the third motion vector, NEW_MV0, based on the first motion vector, MV0, and the MVD information, and deriving the fourth motion vector, NEW_MV1, based on the second motion vector, MV1, and the MVD information.

41. The method of claim 38, wherein determining the modified motion information, NEW_MI, based on the base motion information, BASE_MI, and the MVD information comprises:
determining whether a second criterion, C2, is fulfilled, wherein the base motion information, BASE_MI, contains at least a first motion vector, MV0, and a second motion vector, MV1;
if the second criterion, C2, is fulfilled, (i) determining that the modified motion information, NEW_MI, contains only one motion vector, either a L0 motion vector or a L1 motion vector; (ii) deriving the modified motion information, NEW_MI, based on the corresponding motion vector of the base motion information, BASE_MI, and the MVD information, such that the modified motion information, NEW_MI, is determined based on the first motion vector, MV0, and the MVD information if the modified motion information, NEW_MI, is determined to contain the L0 motion vector, and the modified motion information, NEW_MI, is determined based on the second motion vector, MV1, and the MVD information if the modified motion information, NEW_MI, is determined to contain the L1 motion vector; and
if the second criterion, C2, is not fulfilled, (i) determining that the modified motion information, NEW_MI, contains at least a third motion vector, NEW_MV0, and a fourth motion vector, NEW_MV1, (ii) deriving the third motion vector, NEW_MV0, based on the first motion vector, MV0, and the MVD information, and (iii) deriving the fourth motion vector, NEW_MV1, based on the second motion vector, MV1, and the MVD information.

42. The method of claim 41, wherein the second criterion, C2, is based on a picture coding type of the current picture.

43. The method of claim 42, wherein the second criterion, C2, is fulfilled when the current picture is a non-low-delay picture and the second criterion, C2, is not fulfilled when the current picture is a low-delay picture.

44. The method of claim 41, wherein the second criterion, C2, is further based on whether a magnitude of the MVD information exceeds an MVD threshold.

45. The method of claim 44, wherein the second criterion, C2, is fulfilled when the magnitude of the MVD information exceeds a quarter-pel distance in an x-component or y-component.

46. The method of claim 41, wherein, when the second criterion, C2, is fulfilled, the modified motion information, NEW_MI, is determined to contain only the L0 motion vector when an associated index value, IDX, of the base motion information, BASE_MI, is divisible by 2, and otherwise the modified motion information, NEW_MI, is determined to contain only the L1 motion vector.

47. A decoder for decoding a current block within a current picture inside a coded video bitstream, the decoder comprising a processor and instructions stored in a non-transient computer-readable medium that, when run, cause the processor to:
determine that the current block is coded using geometric partition mode (GPM);
in response to determining that the current block is coded using GPM, determine that at least one partition, PX, of the current block is inter coded;
in response to determining that at least one partition, PX, is inter coded, generate a GPM motion information list, LIST_FINAL;
determine motion information, MI_PX, associated with the partition, PX, based on the GPM motion information list, LIST_FINAL, and an index value, IDX, wherein the associated motion information, MI_PX, contains more than one motion vector; and
determine prediction samples of the partition PX based on the associated motion information MI_PX,
wherein generating the GPM motion information list, LIST_FINAL, further comprises:
generating an initial motion information list, LIST_INIT, based on previously decoded blocks;
determining whether to apply an extraction process to the initial motion information list, LIST_INIT, based on whether a first criterion, C1, is fulfilled, wherein the extraction process extracts motion information containing only one motion vector; and
if the first criterion is fulfilled, performing the extraction process to the initial motion information list, LIST_INIT, and setting the GPM motion information list, LIST_FINAL, to be an output of the extraction process; and, if the first criterion is not fulfilled, setting the GPM motion information list, LIST_FINAL, to be the initial motion information list, LIST_INIT.

48. A computer program comprising instructions stored in a non-transient computer-readable medium which when executed by processing circuitry of a node, causes the node to:
determine that the current block is coded using geometric partition mode (GPM);
in response to determining that the current block is coded using GPM, determine that at least one partition, PX, of the current block is inter coded;
in response to determining that at least one partition, PX, is inter coded, generate a GPM motion information list, LIST_FINAL;
determine motion information, MI_PX, associated with the partition, PX, based on the GPM motion information list, LIST_FINAL, and an index value, IDX, wherein the associated motion information, MI_PX, contains more than one motion vector; and
determine prediction samples of the partition PX based on the associated motion information MI_PX,
wherein generating the GPM motion information list, LIST_FINAL, further comprises:
generating an initial motion information list, LIST_INIT, based on previously decoded blocks;
determining whether to apply an extraction process to the initial motion information list, LIST_INIT, based on whether a first criterion, C1, is fulfilled, wherein the extraction process extracts motion information containing only one motion vector; and
if the first criterion is fulfilled, performing the extraction process to the initial motion information list, LIST_INIT, and setting the GPM motion information list, LIST_FINAL, to be an output of the extraction process; and, if the first criterion is not fulfilled, setting the GPM motion information list, LIST_FINAL, to be the initial motion information list, LIST_INIT.
